(19) United States
(12) Patent Application Publication
(10) Pub. No.: US 2011/0211221 A1
(43) Pub. Date: Sep. 1, 2011

(54) Method and System for Photo Identification and Distribution

(75) Inventor: Patrick William Smits Van Waesberghe, Amsterdam (NL)

(73) Assignee: PHOTONIC B.V., Amsterdam (NL)

(21) Appl. No.: 12/993,189

(22) PCT Filed: May 18, 2009
(86) PCT No.: PCT/NL09/00118

§ 371 Date: Feb. 16, 2011

(30) Foreign Application Priority Data
May 17, 2008 (NL) 1035430

(51) Int. Cl. G06K 9/18; G06F 15/00

(52) U.S. Cl. 358/1.15; 382/182; 382/183

(57) ABSTRACT

The present invention relates to a method for identifying at least one photo from a set of photos, wherein use is made of tokens, the method comprising steps for:—making at least one subject image recording, such as a photo and/or a video, of a subject as part of a set of recordings by means of an image recording device with a image recording member,—making, as part of the set of recordings and by means of the image recording device, a token information recording of information identifiable by at least one token wherein it is the case that:—the at least one subject image recording can be identified by means of the information from a preceding or following token in the set of recordings.

It is known to take photos of people at events or for instance in amusement parks, so that these photos can be taken home or distributed via internet. Such photos must be identified accurately with a receipt which is provided to the person having their photo taken. For this purpose the photo must be associated with this receipt. This is a labour-intensive process requiring complex operating processes and storage systems.

In order to provide a simpler process to enable such photos to be provided to the correct person the present invention provides a method for identifying at least one photo from a set of photos, wherein use is made of tokens, the method comprising steps for:
making at least one subject image recording, such as a photo and/or a video, of a subject as part of a set of recordings by means of an image recording device with an image recording member,
making, as part of the set of recordings and by means of the image recording device, a token information recording of information identifiable by at least one token, wherein it is the case that:
the subject recordings and the token information recording are separate recordings which can be associated with each other by applying a sequence logic,
the at least one subject image recording can be identified by means of the information from a preceding or following token in the set of recordings.

In this method the subject image recording is the photo which the person should receive. A first advantage of such a method according to the present invention is that, because different recordings are applied for the token information and for the subject, the token information does not have to be visible on the subject recording.

The token information recording is a recording for the purpose of storing the token information in a memory of the image recording device. A further advantage of such a method according to the present invention is that the information from the token information recording can be combined in a logical sequence which can be stored in a memory of the image recording device. Once the subject image recordings and the associated token information recordings have been made, the person can hereby take the token with him/her and the association between the two types of recording can be made in automated manner while the token and the person are no longer present. The photographer does not have to perform any operations here for the purpose of making a logical connection between the information required to associate the correct person with the correct photo.

By making the logical connection the set is preferably subdivided into series, each comprising at least one subject recording and at least one token information recording. Performing the subdivision into series according to the present invention in suitable manner achieves that, on the basis of having or knowing the token or the token information, a person can gain access to a print or file comprising the subject recording after the recording has been made.

A first preferred embodiment relates to a method wherein the token comprises an optically recognizable identification image and/or the token information recording is made with the same image recording member as the subject image recording.

This preferred embodiment has the advantage that the photographer need only make recordings, i.e. alternately token information recordings and subject image recordings, both of which are stored in a photo memory of the camera. “Alternately” is understood here to mean that there is a certain amount of freedom in the sequence in which the recordings are made. This does not necessarily have to be alternately a subject recording and a token information recording. After completion of the set all photos of the set are transferred to a processing unit such as a computer or a server for making the logical connection. It is however also possible to arrange such processing means in the camera. Other than making recordings, the photographer does not have to perform any separate operations here either for the purpose of making a logical connection between the information required to associate the correct person with the correct photo.

In a further preferred embodiment of the method the token information comprises image information, such as a text or a graphic representation such as a barcode or two-dimensional graphic code. It hereby becomes possible to apply a large amount of information since it is possible to record a great deal of information in a recording. It hereby becomes possible to also identify the set, which further prevents mistakes in the identification of photos in different set. A large number of information input operations would be required for this purpose in the prior art. A further advantage is that only one apparatus is required for both types of recording.

Associations are preferably established between token information and subject image recordings on the basis of chronology for the purpose of defining series. A fixed frequency of token information recordings and subject information recordings can hereby be applied, although multiple tokens can also be read into a token information recording.

If the token information comprises function information it becomes possible to apply such function information during the handling, processing or distributing of the photo of the subject image recording. Specific personal wishes can hereby be recorded simply by means of making a recording of a token. A discount can be recorded in a code of a token. A processing code can also be incorporated in the token, such as printing of the photo in colour, black and white or for instance sepia.

The method preferably further comprises steps for identifying a token or token information on a recording. These steps preferably comprise image analysis steps for recognizing a barcode or two-dimensional code. It is however also possible for the code to comprise only text, which is recognized by means of optical text recognition means suitable for this purpose.

The information from all recordings is preferably transferred to a central information storage system by means of transfer steps for transferring information relating to at least a part of a set of recordings. The distribution of the recordings from such a storage location to the end user, who is generally included in the subject of a recording, can hereby be realized on the basis of the token information.

Access is preferably provided to one or more image recordings by means of a computer network on the basis of the relevant token information. Use is preferably made here of the internet, although private, mobile or other networks are likewise possible.

In a further preferred embodiment the tokens are cards with token information in the form of an imprint. These can easily be carried by a photographer or group of photographers responsible for photos. Within the scope of the present invention the only technical aids necessary for the work in the field during an event are therefore suitable sets of tokens and cards, while in the prior art all kinds of computer means were necessary to make the correct association between the photos and the persons who would be later entitled to the photos. A large amount of material is hereby saved, and the risk of loss of or damage to expensive equipment is eliminated.

A further aspect of the present invention relates to tokens with token information suitable for application in a method according to the present invention. Preferably envisaged here are a set of cards with a barcode print, preferably having a print which can be read by people. A logical sequence of the cards can be realized in a data file.

Alternatively, the token information is arranged on the token by means of a wirelessly readable member such as RFID. In this case the recording device can read and store this information wirelessly in the memory for the subject image recordings. The image recording device is itself, or by means of a plug-in solution, suitable here for recording the radio-transmittable information of the token.

The tokens are preferably bundled or combined into collections or sets of tokens for the purpose of processing an entire anticipated set of recordings.

A further aspect of the present invention relates to a server computer for making available subject image recordings recorded by means of a method according to the present invention and/or by means of tokens according to the present invention, comprising:
a computer, comprising a processing unit, at least one form of storage memory and network connection options,
request processing means for processing a request for subject image recording on the basis of token information,
retrieving means for retrieving the correct subject image information from the storage means, and
output means for outputting a transmission of the subject image recording via the computer network.

An advantage of such a server is that the subject recordings can be distributed via the computer network and can be retrieved by the person carrying the token.

The server computer preferably comprises information associating means for making an association between the subject image recording and the token information. This can be embodied as a software or hardware implementation for performing the necessary steps. For the purpose of making the token information recordings and the subject image recordings the server is preferably provided with a coupling member for making a coupling to an image recording device.

A further aspect of the present invention relates to a client for making a connection to an image recording device for the purpose of making the token information recordings and the subject image recordings, comprising:
a computer, comprising a processing unit, at least one form of storage memory,
coupling means for coupling the client to an image recording device for the purpose of making the token information recordings and the subject image recordings, and
output means for outputting the subject image recordings.

By means of such a client the photographer can make the images and the associated identification available to the person with the token or to a said server according to the invention.

A further aspect of the present invention relates to a mobile computer with image recording device suitable for performing image recording and processing steps regarding an image recording, provided with the coupling means of the client according to the present invention and/or the server according to the present invention.

An advantage of such a mobile computer is that multiple parts of the method according to the present invention can be performed from the mobile computer, and therefore from an apparatus. One of the limitations here however is the network connection available to the mobile computer. Further limitations are the processing and storage capacity available on a mobile computer, although such limitations will lose significance when mobile computers are given greater capacities due to developments in this specific field.

A further aspect of the present invention relates to a printing device for printing subject image recordings, suitable for functioning within a method according to the present invention in combination with tokens according to the present invention, comprising:
a computer, comprising a processing unit, at least one form of storage memory and network connection options,
request processing means for processing a request for subject image recording on the basis of token information,
retrieving means for retrieving the correct subject image information from the storage means, and
a printing unit for printing image recordings.

Using such a device a number of steps of the method according to the present invention can be performed during an event and prints of the correct photo can be provided to the person with the respective token.

Such a printing device preferably comprises means of a server according to the present invention and/or means of the client according to the present invention.

Further advantages, features and details of the present invention will be explained hereinbelow on the basis of a more detailed description of preferred embodiments, with reference to the accompanying figures, in which:

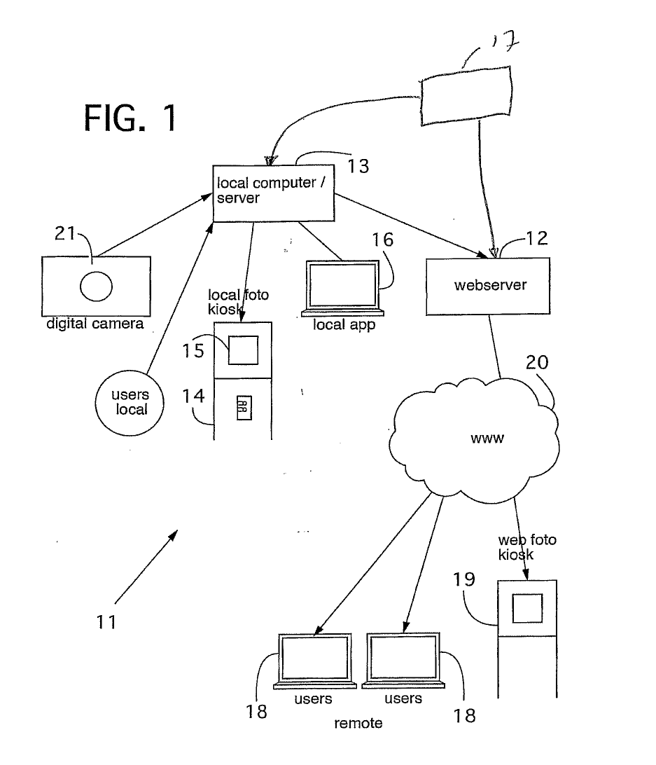

FIG. 1 is a schematic representation of a first preferred embodiment according to the present invention;

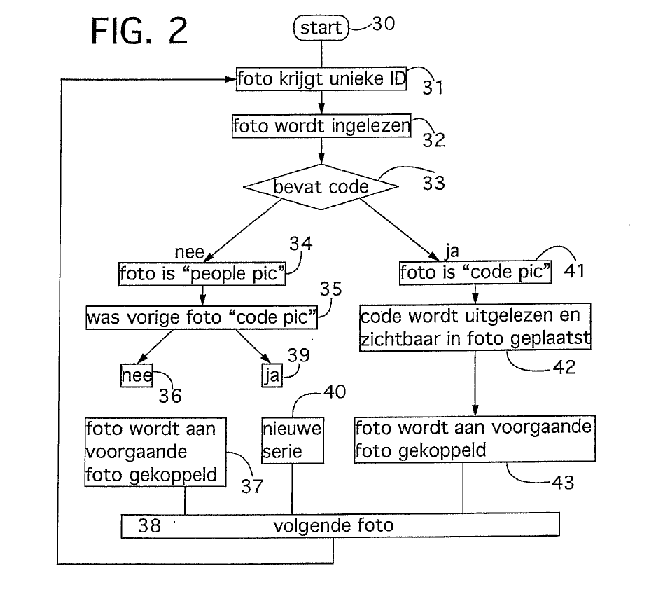

FIG. 2 shows a flow diagram of a preferred embodiment of a method according to the present invention;

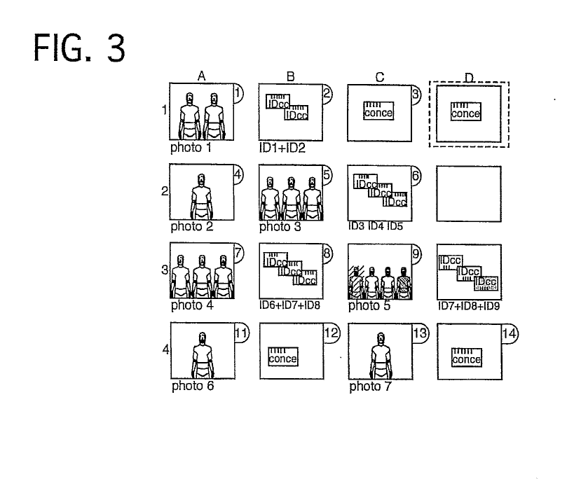

FIG. 3 is a schematic representation of four examples of recording sequences according to the present invention;

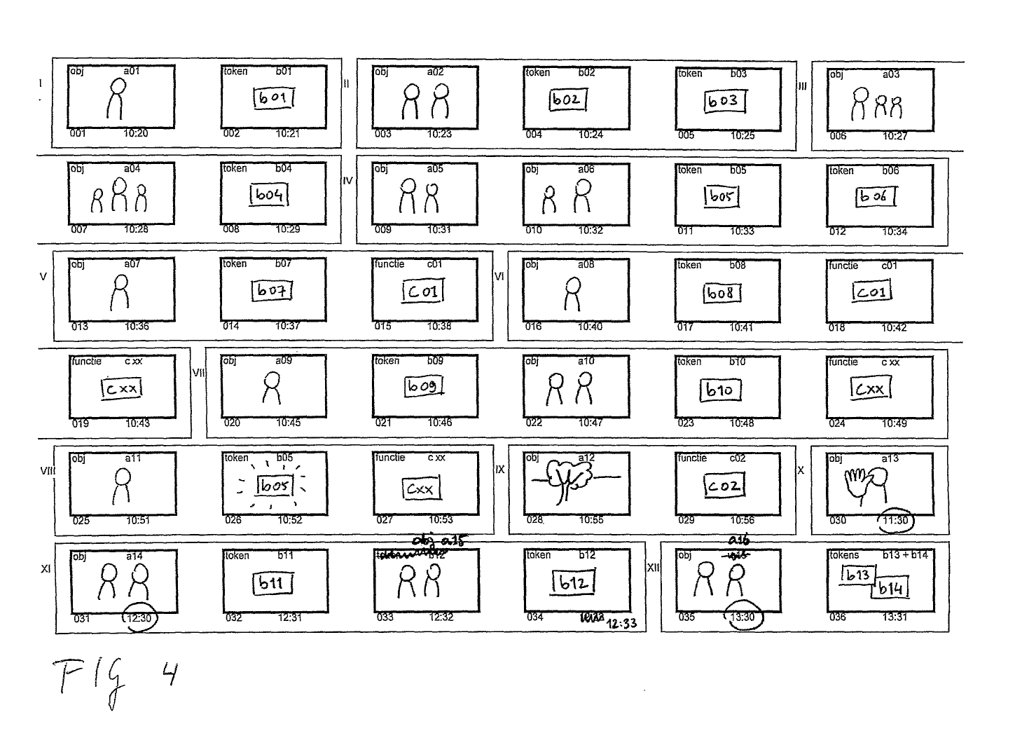

FIG. 4 is a schematic representation of four examples of recording sequences according to the present invention;

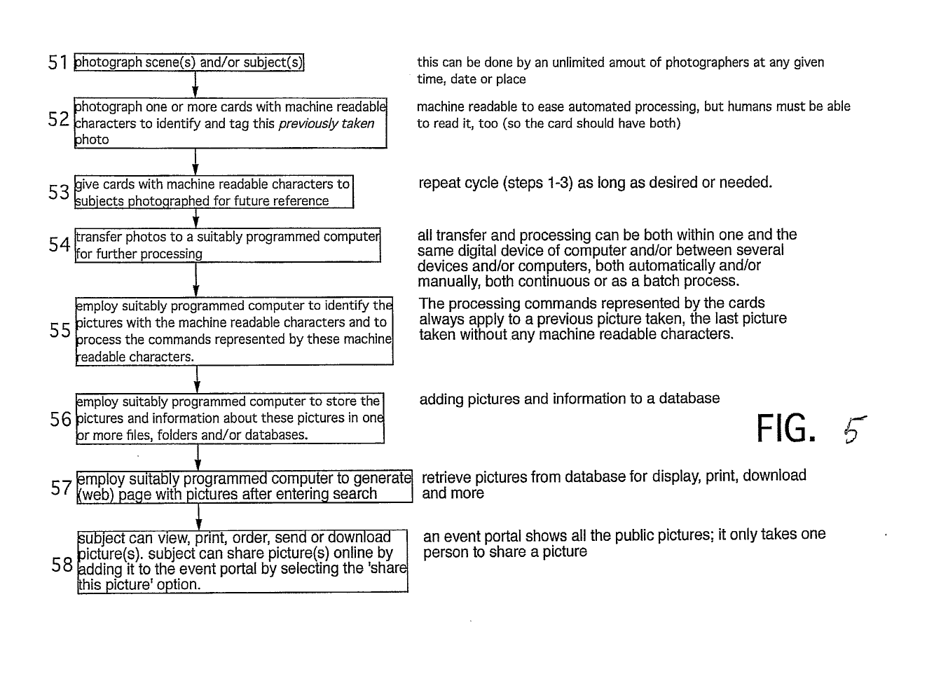

FIG. 5 shows a flow diagram of a preferred embodiment of a method according to the present invention;

FIG. 6 is a schematic representation of a set of recordings according to further preferred embodiments according to the present invention.

In this detailed description a series is defined as comprising a minimum of a subject photo and a token photo, which form part of a set of photos taken using a photo camera. Subject photos not belonging to the series do not occur within a series.

Within the scope of the present invention at least the following types of recording are defined within a set of photos:
1. a subject photo (object image recording, subject image recording) for recording an image of an object or a person;
2. a token photo (token recording, token information recording) for recording the information present on a token with a unique code;
3. a function photo (function recording, variant of a token photo) for indicating a function of the series of photos, such as indicating that the person entitled to the set may for instance receive a free print.

According to the present invention, there are therefore present within a set of photos a large number of series which are all identified by means of at least one token photo, or the subject of which is identified as one of the subjects on the photo by means of at least one token photo.

There are a number of possibilities for identifying the end of a series or the beginning of a subsequent series within a set:
1. the transition from a token photo or a function photo to a subject photo on which no token is displayed;
2. indicating a special function photo at the end of a series;
3. a determined amount of time which has elapsed between two successive recordings can be used as series transition, or a forced series transition;
4. the end of a series can be associated by means of adding information to one of the recordings in the set in order to indicate a transition by means of a menu function on the recording device.

A first preferred embodiment (FIG. 1) according to the present invention relates to a distribution system 11 on the basis of the internet 20 for the purpose of distributing photos taken according to a method according to the present invention.

The recording method according to FIG. 5 is first described. In step 1 a situation or one or more persons are photographed in step 51. The subject image recording is hereby recorded on a memory of a digital camera, although it is also possible for an analog camera to be applied, the images of which are digitized at a later stage. A number of token cards are then photographed in step 52 for the purpose of identifying the previous photo. It is the case here that, for each token which is identifiably recorded on the second photo, access must be provided to the previous photo. In other words, this second photo provides the first photo with a tag with the tokens of the second photo.

It is the case here that the tokens can take on a plurality of forms, such as clothing tags, wristbands, caps, sunglasses etc.

In step 53 the tags or cards are given to the person entitled to the photo. In step 54 the photos are transferred to a computer for further processing thereof. The computer is provided here with software for executing such processes, which a suitable programmer will be able to perform within the scope of the present invention.

In step 55 the computer identifies the machine-readable information, such as the text characters, barcodes and the like, by means of the suitable software so that this information can be stored associated with the correct photo, this being performed in step 56.

In step 57 the photos are made available via the computer network to the holder of a token via a web page in a web browser suitably constructed for this purpose, or an equivalent alternative which can be used for this purpose. The skilled person will recognise and be able to give substance to such alternatives within the scope of this invention.

In step 58 the person can view the photo in detail and print, order, send, download or share it on the basis of the token information.

Returning to FIG. 1, this system is now described. The photos are taken and token information recordings made by means of camera 21. These recordings can be transferred to the local client computer or server 13 for sending to web server 12, the local photo kiosk 15 with printing device (not shown) and user interface by means of screen 15, or local computer 16 which can for instance be used by the user or photographer to perform operations relating to the photos. Alternatively, the photos can be taken using mobile device 17, such as a smart phone. Such a mobile device can also be a PDA or video camera with which videos can be recorded. The video camera can record the tokens in still shots or by means of a short video recording.

The image information recorded on computer 13, web server 12 or one of the other devices can be distributed via the internet 20 to computers 18 or photo kiosks 19 connected to the internet. As will be understood, all sorts of further computerized devices, such as mobile devices, can be used by the persons with the tokens in order to obtain the photos.

An alternative embodiment of the method is now described on the basis of FIG. 2. The starting point here is that a set of photos is taken on a camera and that according to the present invention they must be associated with the token information. In this example this takes place in a process for an entire set. The photos with the subject images and the token information are alternately in the camera memory or have been transferred to the client computer.

The method begins in step 30 with retrieving the first photo. In step 31 a first photo made using the camera is provided with an identification, such as a database identification. In step 32 the image information is read from the photo. In step 33 the analysis determination is made as to whether the image comprises token information or whether it is a subject photo. If it is a subject photo, the method continues in step 34. If it is a token information photo, the method continues in step 41.

In step 34 it is therefore established that the photo is a subject photo, after which it is determined in step 35 whether the previous photo comprises a token information. If this is not the case, this is determined in step 36, and in step 37 the photo is then associated with the previous photo. If the previous photo is a token information photo, this is determined in step 39, after which a new series is started in step 40.

If it is determined in step 41 that the photo is a token information photo, the code is optionally read in step 42 and placed visibly in the photo. The token information is associated with the token information photo as digital information. In step 43 this token is associated with the previous photo. In step 38 the subsequent photo is retrieved and the method continues with step 31. If there is no subsequent photo, the method is ended.

FIG. 3 shows photo sequences which can occur when performing a method according to the invention. The sequences in which the photographer takes the photos is shown.

Row 1 shows that the photographer takes a subject photo A with two people and then a token information photo B with two tokens 101 and 102, each associated with one of the two people in photo A. In photo C of row 1 the photographer takes a bonus token photo. This means that the user of the tokens of the previous photo are entitled to a special treatment, such as a free photo. At the end of the series the photographer takes a photo D with a token thereon which signifies the end of the series.

Row 2 shows the following series. Photo A is a recording of a person. Photo B is a recording of three people. Photo C is a recording of three tokens. In this sequence these tokens have the result that this series of in this case these three photos is ended. The tokens are held by the 3 people who will in this case all gain access to both photos. The transition from the final photo of this series to the first subject photo (not token photo) of the subsequent series indicates the division between these series.

Two series are shown in row 3. Photo A is a photo of three people. Photo B is a photo of three tokens. This first series is hereby concluded. The three people in the first photo gain access to the first photo on the basis of the tokens on the second photo. Photo C is a subject photo. Photo D is a photo of the tokens of the people who will gain access to the photo. The tokens of two people are here the same. It is thus possible to allow multiple photos from different series to be accessible to token holders who appear in multiple series. Each token holder can hereby obtain a personalized set of photos.

In row 4 photo A is a photo which is immediately assessed as not having come out well. In order to reject this photo for further processing, a photo B is immediately taken with a token which has the meaning of remove the previous photo. Photo C relates to a successful photo C, and the subsequent token photo D is therefore taken of a normal token for delivery of the photo to the person who is given this token after token photo D is taken. The first two recordings and the second two recordings each form a series.

FIG. 4 shows a set of photos of 36 photos made successively using one photo camera. This set of 36 photos comprises 12 series. These series are now described successively.

Series 1 relates to a subject photo and a token photo. The token of the token photo is associated with the person on the subject photo. Using the token the person can gain access to the subject photo, for instance by purchasing it at a sales point, such as a kiosk or by means of retrieving the photo via internet. The transition between series 1 and series 2 is defined by a token photo followed by a subject photo (the first photo of series 2).

Series 2 comprises 3 photos. The first photo is a subject photo. The other two photos are token photos which are in this case associated with the two people in the first photo. The two people can gain access to the first photo on the basis of the tokens. The transition between series 2 and series 3 is defined by the presence of a token photo followed by a subject photo (the first photo of series 3).

Series 3 comprises 3 photos. The first 2 photos are subject photos. These two photos are followed by a token photo. The transition between series 3 and series 4 is defined by the presence of a token photo followed by a subject photo (the first photo of series 4). Because there are a token photo and 2 subject photos in this series, the holder of the token gains access to both subject photos.

Series 4 comprises 4 photos. There are 2 subject photos and 2 token photos here. The transition between series 4 and series 5 is defined by a token photo followed by a subject photo (the first photo of series 5). The holders of the two tokens gain access to both subject photos.

The fifth series relates to a photo of a subject and 2 token photos. The transition between series 5 and series 6 is defined by the presence of a token photo followed by a subject photo (the first photo of series 6).

The first token photo is an access token, or an identification token, similar to the token of series 1. The second token photo is a function photo of a function token. This function token can associate a determined function, such as “free photo” or “special photo”, with the series or with the subject photo of the series. Such a special photo can be easily identified on the basis of such a label, and can for instance be used in a slide show about an event.

The sixth series comprises 4 photos. The first photo is a subject photo. The second photo is an identification token photo similar to the token photo of the first series. The third photo is a function photo similar to the function photo of series 5. The fourth photo is a special function photo for indicating the end of the series. Such a photo can be applied by a photographer as hard indication that a new series must be started. It is for instance possible that a photographer, when taking a set of photos, is no longer 100% certain whether the series sequence is still correct. In this case the photographer can photograph a special token in order to obtain such certainty. After such a photo the first subsequent photo is always a first photo of a new series.

The seventh series comprises five photos. In this series a subject photo, a token photo, a subject photo and a token photo succeed each other. The photographer however receives a request from the people in question that the holder of the first token must also be given access to the second photo, and that the holder of the second photo must also be given access to the first photo. The application of a token which indicates the end of a set, similar to the final photo of series 6, provides this option and is interpreted within the concept of the present invention as a hard cut between two series. In this case the transition between the first token photo and the second subject photo is not therefore interpreted as a transition between 2 series, but these five photos are interpreted as a series.

Series 8 comprises 3 photos. The first photo is a subject photo. The second photo is a token photo. The third photo is a specific token photo, i.e. the token photo which indicates the end of a set, as in series 6 and series 7. The first token photo is a photo of the same token as the first token photo of series 4. The holder of this token hereby gains access to both subject photos of series 4 as well as the subject photo of series 8.

Series 9 comprises 2 photos. The first photo is a subject photo which is not specifically associated with an access token similar to the token photo of series 1. The photographer taking this photo is however of the opinion that this photo is important for the set of photos or the event for which the set of photos is being taken. The photo relates for instance to a group of people or a place of interest. In order to associate this information with the subject photo a special function token is photographed in the token photo. The subject photo can hereby be later identified from the set for the purpose of for instance a photo album or a slide show.

Series 10 comprises one photo. Because there is a time lapse between this one photo of series 10 and the first photo of series 11, a clear transition is defined. The photo of series 10 is therefore not associated with series 11. Because the photo of series 10 is further not associated with an identification token, this photo cannot be retrieved at a later stage, at least not in an automated manner according to the present invention.

Series 11 comprises 4 photos. The first photo is a subject photo. The second photo is a token photo. The third photos is another subject photo. The fourth photo is another token photo. Because the first photo of the second series was taken much later than the fourth photo of the first series, it is assumed that the actual transition between the first and second series is such that the 4 photos of the first series together form a series. A determination of the normal transition is hereby replaced by one of the time lapse. A practical example where this may be advantageous is that in which baby photos are taken. The photos within a session are taken in relatively quick succession, interrupted by a break during which the photographer sees out the baby with parents and welcomes other parents with baby. The duration of this break can be used to be certain that a series separation is assumed and no photos end up in the wrong series, even if a token photo at the end of the preceding series has been forgotten.

Series 12 comprises two photos, a subject photo and a token photo. The token photo comprises two tokens. These tokens are each interpreted individually as if they had been recorded on separate photos. This provides the advantage that the photographer need take fewer photos and that less storage capacity is necessary.

FIG. 5 shows a schematic view of a further example of a method according to the present invention. In step 51 a photographer takes photos of scenes and/or subjects such as people. This can be done in practice by one or more photographers. Each photographer produces a set of recordings which can later be subdivided into series in the memory of his/her photo camera. As described in the foregoing, subject recordings are here alternated with token recordings.

In step 52 the photographer photographs one or more cards, or tokens, with information thereon which can be interpreted by a computer, such as one-dimensional or two-dimensional barcodes, or merely clearly printed characters, or a combination thereof.

In step 53 the cards photographed in step 52 are given or returned to the people who may later acquire the photos with the subjects. These three steps can be repeated a number of times.

In step 54 the photos are transferred to a suitably programmed computer for further processing thereof.

In step 55 the set of photos is subdivided into series on the basis of the information of the code photos and the sequence of the photos in the set. It is possible here that the transition from a code photo to a subject photo (a photo without code information) is interpreted as the end of a set. The reverse is however also possible within the scope of this invention.

It is possible to subdivide the different recordings into series on a central computer. It is however also possible for the subdivision into series to be already carried out on the same device with which the photos are taken. The subdivision into series can be carried out in a continuous manner as well as in a batch process.

An advantage of subdividing the photos into series in the camera is that the photo can already be provided in the camera with information relating to the code photos associated with the series. In this case the image information of the code photos does not need to be transmitted separately to the computer. However, this variant requires software and computing power in the camera which is generally not available. In the case the camera is integrated into a mobile computer or a mobile telephone, this is however feasible.

In step 56 the subject photos are provided with one or more data fields, for example in EXIF metadata, on the basis of the sequence information, or the photo is stored in a database comprising such data fields. Such a database can for instance be used to provide access to the photos. This can take place in indirect manner by means of providing prints, but can also take place in direct manner by means of providing user access, for instance via Internet.

In step 57 such an access to the database is provided for the purpose of displaying the photo on a screen, printing a photo on paper, downloading a photo to a memory and the like.

In step 58 the photo can be shared in further ways. The user can for instance give someone else access to the photo. An example thereof is that the user can order the photo album for all the other participants in a specific event. It is for instance further possible that, of a large number of code cards, part is arranged in a specific group. One of the group members can for instance make one or more photos available to the other group members.

A wide variety of patterns can be envisaged on the basis of which photos can be associated with tokens within the scope of the present invention. In addition to the identification of a subject photo on the basis of a separate token photo, it is possible to associate the information of a token with a subject photo by means of an input on the recording apparatus. A menu option can be provided for this purpose by means of a suitable software application.

Further examples of preferred embodiments are as follows. When making photos of large groups of people available online, it is advantageous according to the present invention that people gain access only to the photos associated with their respective tokens. The load on the servers and networks hereby remains limited because people cannot and need not browse through all the photos without limitation. The larger the number of people, tokens and/or photos, the greater this advantage is. The method according to the present invention is highly flexible since the associating of photos and tokens can be performed very spontaneously and easily, whereby the exchange of group photos can simply be carried out by means of photographing the respective tokens after for instance taking a group photo. On the basis of the uniqueness of the different tokens it is easy to perform further activities therewith, such as a lottery, a competition or a loyalty scheme.

The present invention is described in the foregoing on the basis of several preferred embodiments. Different aspects of different embodiments are deemed described in combination with each other, wherein all combinations which can be made by a skilled person on the basis of this document must be included. These preferred embodiments are not limitative for the scope of protection of this document. The rights sought are defined in the appended claims.

1. A method for identifying at least one photo from a set of photos, wherein use is made of tokens, the method comprising the steps of:
making at least one subject image recording, such as a photo and/or a video, of a subject as part of a set of recordings by means of an image recording device with an image recording member, and
making, as part of the set of recordings and by means of the image recording device, a token information recording of information identifiable by at least one token, wherein:
the subject recordings and the token information recording are separate recordings which can be associated with each other by applying a sequence logic, and
the at least one subject image recording can be identified by means of the information from a preceding or following token in the set of recordings.

2. The method as claimed in claim 1, wherein the token comprises an optically recognizable identification image and/or the token information recording is made with the same image recording member as the subject image recording.

3. The method as claimed in claim 1, wherein the token information comprises image information, such as a text or a graphic representation such as a barcode or two-dimensional graphic code.

4. The method as claimed in claim 1, wherein the set of recordings is chronological for the purpose of establishing associations between token information and subject image recordings on the basis of chronology.

5. The method as claimed in claim 1, wherein the token information comprises function information.

6. The method as claimed in claim 1, further comprising steps for identifying a token or token information on a recording.

7. The method as claimed in claim 1, wherein a subject image recording and a token information recording are made one by one alternately.

8. The method as claimed in claim 1, further comprising steps for transferring information relating to at least a part of a set of recordings to a central information storage system.

9. The method as claimed in claim 1, further comprising associating the information from a token with a subject image recording.

10. The method as claimed in claim 1, further comprising steps for providing access to one or more image recordings by means of a computer network on the basis of the relevant token information.

11. The method as claimed in claim 1, further comprising steps for subdividing a set into series on the basis of the sequence logic.

12. The method as claimed in claim 1, wherein the tokens are cards with token information in the form of an imprint and/or the tokens are wristbands with this imprint and/or the tokens are other types of label with the imprint.

13. Tokens with token information suitable and/or intended for application in a method as claimed in claim 1.

14. The token as claimed in claim 13, wherein the token information is arranged in a visually discernible manner, such as by means of an imprint.

15. The token as claimed in claim 13, wherein the token information is arranged by means of a wirelessly readable member, such as RFID.

16. (canceled)

17. A server computer for making available subject image recordings recorded by means of a method as claimed in claim 1 and/or by means of tokens as claimed in claim 13, comprising:
a computer, comprising a processing unit, at least one form of storage memory and network connection options,
request processing means for processing a request for a subject image recording on the basis of token information,
retrieving means for retrieving the correct subject image information from the storage means, and
output means for outputting a transmission of the subject image recording via the computer network.

18. The server computer as claimed in claim 17, further comprising information associating means for making an association between the subject image recording and the token information and/or herein subdividing a set into series.

19. The server computer as claimed in claim 17, further comprising a coupling member for making a coupling to an image recording device for the purpose of making the token information recordings and the subject image recordings.

20. A client for making a connection to an image recording device for the purpose of making token information recordings and subject image recordings, comprising:
a computer, comprising a processing unit and at least one form of storage memory,
coupling means for coupling the client to an image recording device for the purpose of making the token information recordings and the subject image recordings, and
output means for outputting the subject image recordings.

21. The client as claimed in claim 20, further comprising the server computer in claim 18.

22. A mobile computer with an image recording device suitable for performing image recording and processing steps regarding an image recording, provided with the coupling means of the client of claim 20 and/or the server as claimed in claim 17.

23. A printing device for printing subject image recordings, suitable for functioning within a method as claimed in claim 1 in combination with tokens as claimed in claim 12, comprising:
a computer, comprising a processing unit, at least one form of storage memory and network connection options,
request processing means for processing a request for a subject image recording on the basis of token information,
retrieving means for retrieving the correct subject image information from the storage means, and
a printing unit for printing image recordings.

24. The printing device as claimed in claim 23, comprising the computer server f claim 17 and/or the client as claimed in claim 20.
